(19) United States
(12) Patent Application Publication
(10) Pub. No.: US 2022/0032390 A1
(43) Pub. Date: Feb. 3, 2022

(54) ADAPTABLE USER INTERFACE FOR WELDING WIRE FEEDERS

(71) Applicant: Illinois Tool Works Inc., Glenview, IL (US)

(72) Inventors: Daniel J. Mortensen, Greenville, WI (US); Connor D. Uitenbroek, Appleton, WI (US); Adam R. Schmitz, Neenah, WI (US)

(21) Appl. No.: 17/372,846

(22) Filed: Jul. 12, 2021

Related U.S. Application Data
(60) Provisional application No. 63/059,717, filed on Jul. 31, 2020.

(51) Int. Cl. B23K 9/12; B23K 9/10; B23K 9/32

(52) U.S. Cl. CPC B23K 9/125; B23K 9/32; B23K 9/1087; B23K 9/1062

(57) ABSTRACT

Systems and methods for an adjustable user interface for a wire feeder are provided. In some examples, welding power supplies, welding accessories, and/or welding wire feeders and welding wire feeder systems are equipped with one or more user interfaces adaptable to change position, orientation, or location, relative to a housing or support on which the user interface is secured. The adaptable user interfaces may be secured to a mount (e.g., an enclosure, a case, a surface, etc.) via one or more fasteners (e.g., screws, bolts, magnets, straps, snap-fit, detents, pins, etc.). For example, the fasteners may create a non-permanent joint between the user interface and the mount, such that the position, orientation, or location user interface may be adapted for a desired application.

### CROSS REFERENCE TO RELATED APPLICATIONS

This application is a Non-Provisional Patent Application of U.S. Provisional Patent Application No. 63/059,717 entitled “Adaptable User Interface For Welding Wire Feeders” filed Jul. 31, 2020, which is herein incorporated by reference in its entirety.

### BACKGROUND

In some welding applications, a welding wire feeder may be used to feed welding wire from a wire spool to a welding torch for a welding operation. In some welding operations, it may be desirable for welding wire feeders to be portable. Benefits of a portable wire feeder include being able to locate the wire feeder at work area. However, as an operator moves around the work area, a control or display on the wire feeder may become difficult to read and/or reach. In some welding operations, it may be desirable to employ a wire feeder with an adaptable control or display to accommodate the work area.

### SUMMARY

The present disclosure relates generally to welding systems and, more particularly, to welding wire feeders and welding wire feeder systems having one or more adaptable user interfaces, substantially as illustrated by and described in connection with at least one of the figures, as set forth more completely in the claims.

### DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example welding system employing a wire feeder and a wire feeder source, in accordance with aspects of this disclosure.

FIGS. 2A to 2D illustrate perspective views of an example wire feeder with an adaptable user interface, in accordance with aspects of this disclosure.

FIGS. 3A to 3C illustrate additional perspective views of an example wire feeder with an adaptable user interface, in accordance with aspects of this disclosure.

FIGS. 4A to 4D illustrate additional views of an example wire feeder with an adaptable user interface, in accordance with aspects of this disclosure.

FIGS. 5A to 5C illustrate perspective views of an example wire feeder with an adaptable user interface mounted within an enclosure, in accordance with aspects of this disclosure.

The figures are not necessarily to scale. Where appropriate, similar or identical reference numbers are used to refer to similar or identical components.

### DETAILED DESCRIPTION

Disclosed are example welding systems having one or more adaptable user interfaces, generally. In particular, welding power supplies, welding accessories, and/or welding wire feeders and welding wire feeder systems are equipped with one or more user interfaces adaptable to change position, orientation, or location, relative to a housing or support on which the user interface is secured. The adaptable user interfaces may be secured to a mount (e.g., an enclosure, a case, a surface, etc.) via one or more fasteners (e.g., screws, bolts, magnets, straps, snap-fit, detents, pins, etc.). For example, the fasteners may create a non-permanent joint between the user interface and the mount, such that the position, orientation, or location user interface may be adapted for a desired application.

Conventional welding systems have control panels and/or user interfaces mounted to the housing in a fixed position. Typically, the panels and/or interfaces are facing forward, such as on a front panel with input/output receptacles, with the expectation that the operator will return to the front panel to perform multiple tasks. However, by the very nature of welding, in particular during use of a portable wire feeder, the operator may move around the work area and may not have a single view of the front panel of the welding system.

Additionally or alternatively, by use of a remote and/or system with an automatic setting feature, the operator may not need to return to the welding power supply and/or wire feeder to perform many common tasks (e.g., adjust welding parameter settings, such as when switching between an arc welding process and a gouging process). Thus, the operator may desire to view the user interface (or access a control on the user interface) from multiple angles.

In an example, a wire feeder may be placed on a cart, along with a spool of wire, tools, etc. If the user interface was in a fixed orientation, the operator must be in a position to clearly see the front panel of the wire feeder. However, if the operator is performing a weld above or below a line of sight of the front panel, the operator would have to leave the work space in order to view and/or access the user interface.

Disclosed adaptable user interfaces are configured to change position, orientation, or location, relative to a housing or support on which the user interface is secured. The user interface may include a display screen and/or controls. Such a display and/or controls may be adaptable to changes in arrangement of the welding system. In some examples, two or more surfaces of the welding system includes such a display and controls. In some examples, the system operational parameters can be displayed and/or controlled from one or more of a plurality of user interfaces arranged on two or more surfaces of the welding system. When the welding system is in a first orientation (arranged vertically), a first display and first set of controls are active, whereas in second orientation (arranged horizontally), a second display and second set of controls are active. Activation of the first or second displays and/or controls can be implemented automatically (e.g., in response to an orientation sensor, a placement sensor, etc.) and/or an operator input (e.g., selection of a particular set of displays/controls). In some examples, the user interface employs a configurable display (which may change orientation of displayed text and/or graphics in response to an adjustment in position, orientation, location, etc.), one or more physical controls (e.g., knobs, switches, membrane switches, etc.), and/or touch screen enabled controls.

In securing the adaptable user interfaces to the housing (e.g., via a mount) a manually adjustable fastener may be employed (e.g., without the use of tools, such as by hand-tightened screws, bolts, magnets, straps, snap-fit, detents, removable pins, etc.). In some examples, a detent is a mechanical or magnetic device configured to resist or arrest the rotation of the user interface about a pivot point. Such a device can include a variety of fasteners, as disclosed herein. Additionally or alternatively, a fastener may employ one or more tools to change the position.

In some examples, the movement or rotation of the user interface is unrestricted, such that the user interface may move 360 degrees about the pivot point, may move in one or more degrees of freedom, and/or be removable (e.g., yet maintain a power and/or data connection, by wired and/or wireless connection). For example, a given mount may be able to secure the user interface in a variety of positions, orientations, or locations. In some examples, the housing of the welding system may include multiple mounts configured to receive the user interface, such that the user interface may be removed from a first mount (e.g., with an obstructed view) and secured in a second mount (e.g., with an unobstructed view). In some examples, the user interface comprises a tether or adjustable fastening system (e.g., straps, ties, magnets, etc.), such that an operator may remove the user interface and secure it to any object (e.g., a post, a wall, a lamp, the weld cable, etc.).

In some examples, the mount is fitted with rails to allow the user interface to move within a channel or tract, such that it be conveyed from a first surface (e.g., a lateral side) to a second surface (e.g., a top or bottom side), and/or set at an angle (e.g., by use of a set of pins about which the user interface may pivot). In some examples, the user interface and/or mount may be enclosed within a protective cover (e.g., a cage, a transparent box, etc.) to prevent environmental damage to the user interface while allowing the operator to adjust the position and retain the ability to view and/or access the user interface.

In some examples, the present disclosure may include a wire feeder system with a separate enclosure for a spool of wire. The enclosure for the spool of wire may be separate from and connectable to a portable wire feeder. The portable wire feeder may be significantly lighter than a conventional wire feeder, because the spool of wire is separated from the drive components. Accordingly, both the enclosure for the spool of wire and the wire feeder are easily portable. Additionally, new spools can be conveniently replaced when a welding spool is exhausted.

In disclosed examples, a wire feeder includes a user interface, a housing comprising a mount to receive the user interface, the user interface being secured to the mount by one or more non-permanent joints to allow the user interface to change an angle or a location of the user interface relative to a surface of the housing on which the user interface is secured, and one or more fasteners configured to allow adjustment of a tension on the user interface from the one or more non-permanent joints.

In some examples, the one or more fasteners comprises one or more of a screw, a bolt, a magnet, a strap, a snap-fit, a detent, a magnet, or a removable pin. In examples, the user interface comprises one or more of a control switch or a display. In some examples, a change in the angle or location of the user interface causes a change in an angle or a location of the control switch or the display of the user interface.

In examples, the user interface is removable from the mount. In some examples, the user interface is configured to be removed from the wire feeder and incorporated with another welding-type system, the user interface configured to control the wire feeder or the welding-type system. In examples, the mount includes rails on which the user interface can move within the mount.

In some examples, the wire feeder is secured in an enclosure. In examples, the enclosure is located on a cart.

In disclosed examples, a welding system includes a user interface, a mount to receive the user interface, the user interface being secured to the mount at one or more pivot points to allow an angle of the user interface to change relative to the mount on which the user interface is secured, and a fastener configured to occupy a first position and a second position, wherein the first position allows the user interface to pivot about the one or more pivot points, and the second position fixes the angle of the user interface relative to the mount.

In some examples, the welding system is a wire feeder. In examples, the welding system is a welding power supply. In some examples, the welding system is a remote.

The term “welding system” or “welding-type system,” as used herein, includes any device capable of supplying power suitable for welding, plasma cutting, induction heating, Carbon Arc Cutting-Air (e.g., CAC-A), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding power” or “welding-type power” refers to power suitable for welding, plasma cutting, induction heating, CAC-A and/or hot wire welding/preheating (including laser welding and laser cladding).

As used herein, the term “welding power supply,” “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “torch,” “welding torch,” “welding tool” or “welding-type tool” refers to a device configured to be manipulated to perform a welding-related task, and can include a hand-held welding torch, robotic welding torch, gun, or other device used to create the welding arc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW), shielded metal arc welding (SMAW), spray, short circuit, and/or any other type of welding process.

As used herein, the term “welding program” includes at least a set of welding parameters for controlling a weld. A welding program may further include other software, algorithms, processes, or other logic to control one or more welding-type devices to perform a weld.

As used herein, a “circuit,” or “circuitry,” includes any analog and/or digital components, power and/or control elements, such as a microprocessor, digital signal processor (DSP), software, and the like, discrete and/or integrated components, or portions and/or combinations thereof.

The terms “control circuit” and “control circuitry,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards that form part or all of a controller, and are used to control a welding process, a device such as a power source or wire feeder, motion, automation, monitoring, air filtration, displays, and/or any other type of welding-related system.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), flash memory, solid state storage, a computer-readable medium, or the like.

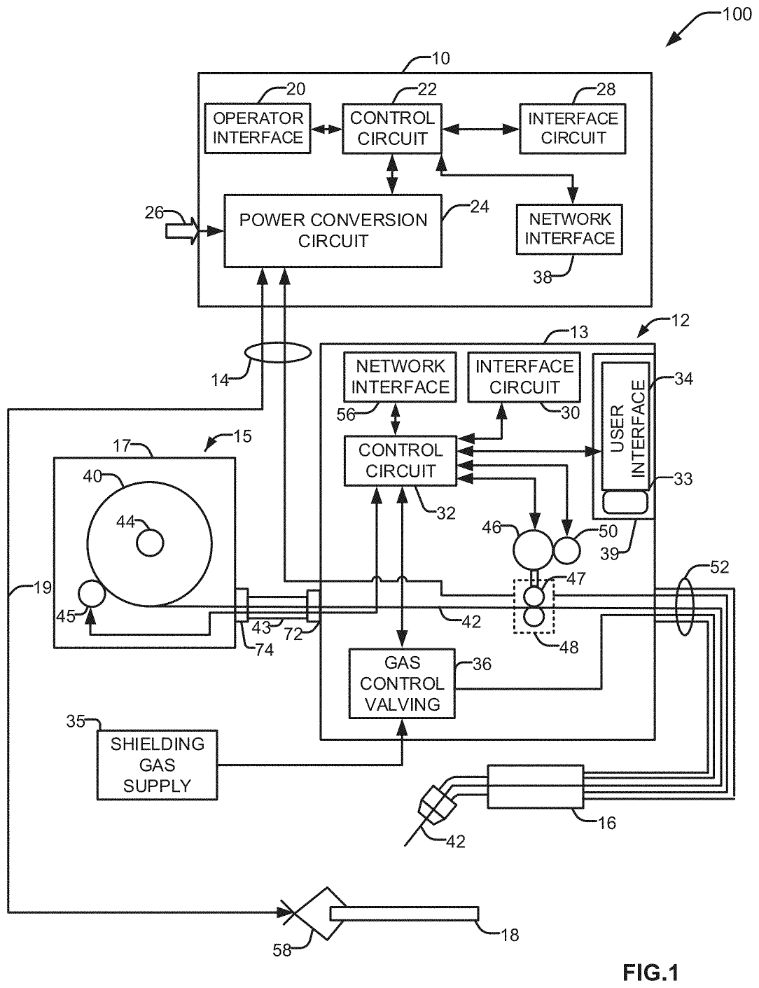

FIG. 1 illustrates an example welding system 100 for performing welding operations. As shown in the welding system 100 of FIG. 1, a power supply 10 and a wire feeder 12 are coupled via conductors or conduits 14. In the illustrated example, the power supply 10 is separate from the wire feeder 12, such that the wire feeder 12 may be positioned near a welding location at some distance from the power supply 10. Terminals are typically provided on the power supply 10 and on the wire feeder 12 to allow the conductors 14 or conduits to be coupled to the systems so as to allow for power and gas to be provided to the wire feeder 12 from the power supply 10, and to allow data to be exchanged between the two devices.

The system 100 is configured to provide wire from a welding wire source 15, power from the power supply 12, and shielding gas from a shielding gas supply 35, to a welding tool or torch 16. The torch 16 may be any type of arc welding torch, (e.g., GMAW, GTAW, FCAW, SMAW) and may allow for the feed of a welding wire 42 (e.g., an electrode wire) and gas to a location adjacent to a workpiece 18. A work cable 19 is run to the welding workpiece 18 so as to complete an electrical circuit between the power supply 10 and the workpiece 18.

The welding system 100 is configured for weld settings (e.g., weld parameters, such as voltage, wire feed speed, current, gas flow, inductance, physical weld parameters, advanced welding programs, pulse parameters, etc.) to be selected by the operator and/or a welding sequence, such as via an operator interface 20 provided on the power supply 10. The operator interface 20 will typically be incorporated into a front faceplate of the power supply 10, and may allow for selection of settings such as the weld process, the type of wire to be used, voltage and current settings, and so forth. In particular, the example system 100 is configured to allow for welding with various steels, aluminums, or other welding wire that is channeled through the torch 16. Further, the system 100 is configured to employ welding wires with a variety of wire sizes. These weld settings are communicated to a control circuit 22 within the power supply 10. The system may be particularly adapted to implement welding regimes configured for certain electrode types. The control circuit 22 operates to control generation of welding power output that is supplied to the welding wire 42 for carrying out the desired welding operation.

The torch 16 applies power from the power supply 10 to the wire electrode 42, typically by a welding cable 52. Similarly, shielding gas from a shielding gas supply 35 is fed through the wire feeder 12 and the welding cable 52. During welding operations, the welding wire 42 is advanced through a jacket of the welding cable 52 towards the torch 16.

The work cable 19 and clamp 58 allow for closing an electrical circuit from the power supply 10 through the welding torch 16, the electrode (wire) 42, and the workpiece 18 for maintaining the welding arc during the operation. Although illustrated with a single torch 16 connected to the wire feeder 12, in some examples multiple torches of a variety of types may be connected to the wire feeder 12. In examples, a gouging or cutting torch may be separately connected to the wire feeder 12 and/or the power supply 10.

The control circuit 22 is coupled to power conversion circuit 24. This power conversion circuit 24 is adapted to create the output power, such as pulsed waveforms applied to the welding wire 42 at the torch 16. Various power conversion circuits may be employed, including choppers, boost circuitry, buck circuitry, inverters, converters, and/or other switched mode power supply circuitry, and/or any other type of power conversion circuitry. The power conversion circuit 24 is coupled to a source of electrical power as indicated by arrow 26. The power applied to the power conversion circuit 24 may originate in the power grid, although other sources of power may also be used, such as power generated by an engine-driven generator, batteries, fuel cells or other alternative sources. The power supply 10 illustrated in FIG. 1 may also include an interface circuit 28 configured to allow the control circuit 22 to exchange signals with the wire feeder 12.

The wire feeder 12 includes a complimentary interface circuit 30 that is coupled to the interface circuit 28. In some examples, multi-pin interfaces may be provided on both components and a multi-conductor cable run between the interface circuit to allow for such information as wire feed speeds, processes, selected currents, voltages or power levels, and so forth to be set on either the power supply 10, the wire feeder 12, or both. Additionally or alternatively, the interface circuit 30 and the interface circuit 28 may communicate wirelessly and/or via the weld cable.

The wire feeder 12 also includes control circuit 32 coupled to the interface circuit 30. As described below, the control circuit 32 allows for wire feed speeds to be controlled in accordance with operator selections or stored sequence instructions, and permits these settings to be fed back to the power supply via the interface circuit. The control circuit 32 is coupled to an operator interface 34 on the wire feeder that allows selection of one or more welding parameters, particularly wire feed speed. The operator interface may also allow for selection of such weld parameters as the process, the type of wire utilized, current, voltage or power settings, and so forth.

In some examples, the wire feeder 12 includes one or more power conversion circuits, which may be similar to power conversion circuit 24. For instance, the power conversion circuits in the wire feeder 12 may include choppers, boost circuitry, buck circuitry, inverters, converters, and/or other switched mode power supply circuitry, and/or any other type of power conversion circuitry to control power output to the welding torch 16 and/or other type of welding tool, as well as one or more auxiliary outputs.

The control circuit 32 may also be coupled to gas control valving 36 which regulates and/or measures the flow of shielding gas from the shielding gas supply 35 to the torch 16. In general, such gas is provided at the time of welding, and may be turned on immediately preceding the weld and for a short time following the weld. The shielding gas supply 35 may be provided in the form of pressurized bottles.

The wire feeder 12 includes components for feeding wire to the welding torch 16 and thereby to the welding operation, under the control of control circuit 32. As illustrated, the drive components and control components of the wire feeder 12 are included within a first housing or enclosure 13. A spool of wire 40 is mounted on a spool hub 44 in a second housing or enclosure 17. The wire source 15 may be integrated with the wire feeder 12. In some examples, the wire source 15 is physically independent from the wire feeder 12. In other words, the wire source 15 is connectable to and disconnectable from the wire feeder 12, and the wire source 15 can be physically moved independently from the wire feeder 12.

In some examples, the spool hub 40 is configured to support up to a sixty pound spool of wire and the enclosure 17 is large enough to enclose a sixty pound spool of wire. An inlet 72 of the wire feeder 12 is connected to an outlet 74 of the wire source 15 via one or more connectors 43. In some examples, the wire feeder inlet 72 is directly connected to the wire source outlet 74. For example, the wire feeder inlet 72 may include a first connector that directly connects to a second connector of the wire source outlet 74. For example, the wire feeder inlet 72 may connect to the wire source outlet 74 via quick disconnect connectors or the like through which wire from the spool 40 may be fed. In some examples, a conduit may connect the wire feeder inlet 72 to the wire source outlet 74. In some examples, the conduit is flexible (e.g., similar to a weld cable). In some examples, the conduit may be a rigid conduit. The connectors 43 enable welding wire 42 from the spool 40 to be fed to the drive components of the wire feeder 12. The connectors 43 may also enable one or more control cables to be connected from components within the wire source enclosure 17 to the control circuit 32.

Welding wire 42 is unspooled from the spool 40 and is progressively fed to the torch 16. The spool 40 may be associated with a clutch 45 that disengages the spool 40 when wire is to be fed from the spool 40 to the torch 16. The clutch 45 may also be regulated, for example by the control circuit 32, to maintain a minimum friction level to avoid free spinning of the spool 40. The first wire feeder motor 46 may be provided within a housing 48 that engages with wire feed rollers 47 to push wire from the wire feeder 12 towards the torch 16.

In practice, at least one of the rollers 47 is mechanically coupled to the motor 46 and is rotated by the motor 46 to drive the wire from the wire feeder 12, while the mating roller is biased towards the wire to apply adequate pressure by the two rollers to the wire. Some systems may include multiple rollers of this type. In some examples, the wire feeder 12 is configured to feed ⅛ inch wire. In some examples, the wire feeder 12 is configured to feed 3/32 inch wire.

A tachometer 50 or other sensor may be provided for detecting the speed of the first wire feeder motor 46, the rollers 47, or any other associated component so as to provide an indication of the actual wire feed speed. Signals from the tachometer 50 are fed back to the control circuit 32 such that the control circuit 32 can track the length of wire that has been fed. The length of wire may be used directly to calculate consumption of the wire and/or the length may be converted to wire weight based on the type of wire and its diameter.

In some examples, the user interface 34 is adaptable to variations in a position, orientation, or location of a respective welding system (e.g., wire feeder 12). For example, user interface 34 may be secured in a mount 39, such as by one or more fasteners 33. The mount 39 may allow the user interface 34 to pivot (on one or more axis), extend from the housing 13 (at an angle and/or parallel to the surface from which it extends), and/or be removed from the mount 39 altogether.

A display and/or controls within the user interface 35 may be adaptable to changes in arrangement of the welding system. Although illustrated with a single user interface 34, two or more user interfaces may be employed, each adaptable as described herein. Further, although shown on a single surface (and in a single mount), multiple surfaces and/or mounts may be provided on the wire feeder 12. Further, power supply 10 may additionally or alternatively employ an adaptable user interface, as disclosed herein.

As disclosed herein, when the wire feeder is in a first location and/or orientation (e.g., arranged vertically and/or at an elevated height), the position, orientation, and/or location of user interface 34 may be changed to accommodate the operator's position in the work environment. Similarly, when the wire feeder is in a second location and/or orientation (e.g., arranged horizontally and/or at a reduced height), the position, orientation, and/or location of user interface 34 may be changed, as provided herein.

In some examples, the user interface 34 employs a configurable display (which may change orientation of displayed text and/or graphics in response to an adjustment in position, orientation, location, etc.), one or more physical controls (e.g., knobs, switches, membrane switches, etc.), and/or touch screen enabled controls. Thus, a change in orientation of the user interface 34 from a first position to a second position may make a first control and/or first display window appear to correspond to a second control and/or second display window (due to height, perspective, angle, etc.). Accordingly, the user interface 34 may reconfigure the display to correspond to the new perspective (such as automatically, in response to a sensor, and/or from a user input).

In some examples, the user interface 34 and/or mount 39 may be enclosed within a protective cover (e.g., a cage, a transparent box, etc.) to prevent environmental damage to the user interface 34 while allowing the operator to adjust the position and retain the ability to view and/or access the user interface.

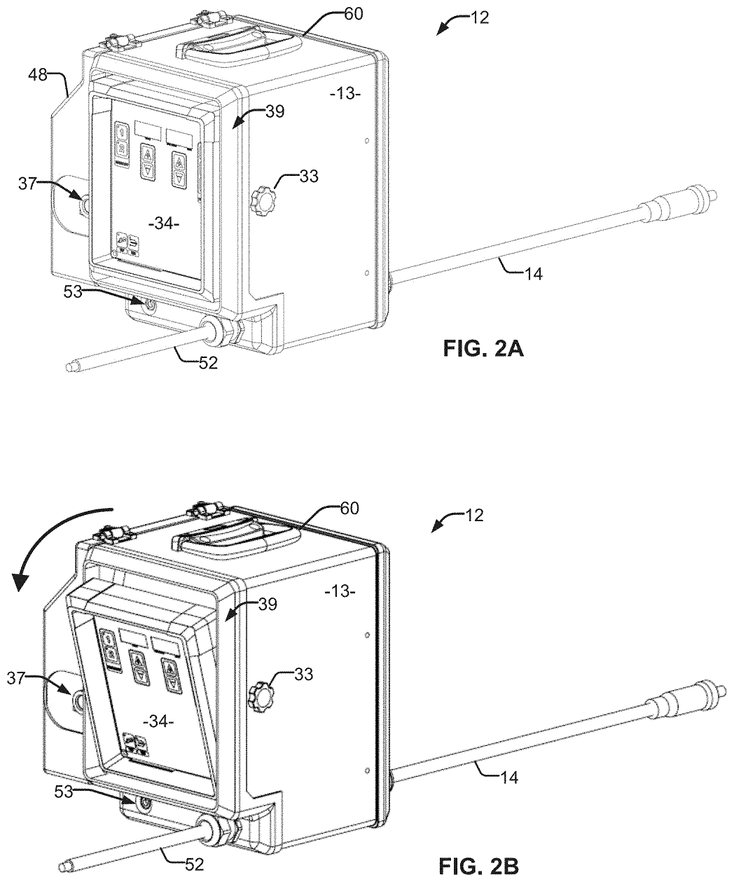

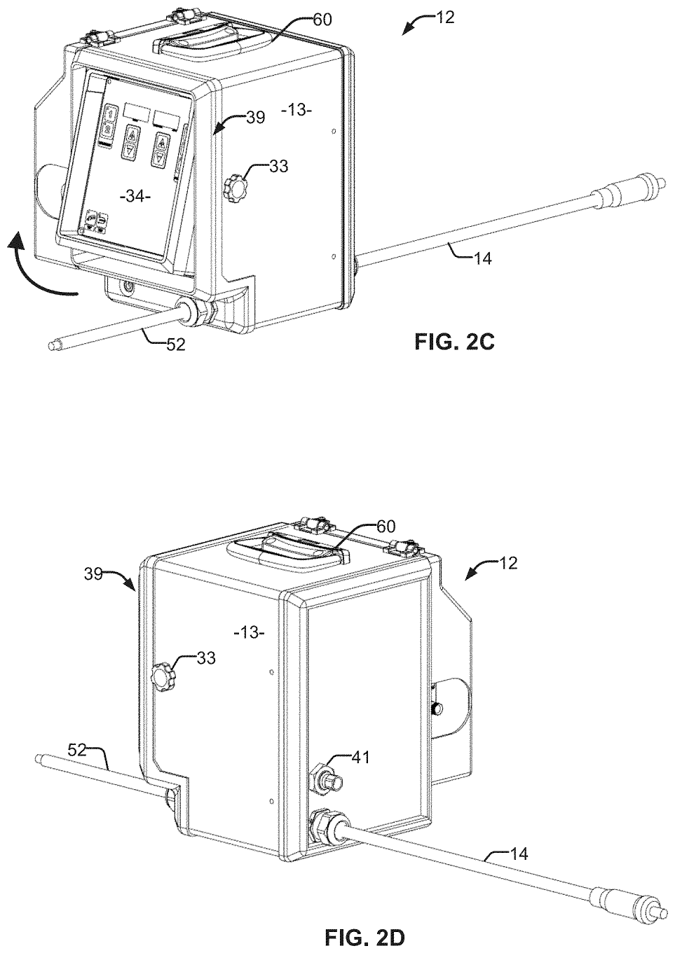

FIGS. 2A to 2D illustrate perspective views of an example wire feeder 12 with an adaptable user interface 34. The wire feeder 12 further includes a volt sense terminal 53, a shielding gas outlet 37, and/or a shielding gas inlet 41, . As shown, in FIG. 2B, the fastener 33 can be adjusted (such as by turning) to release tension on the user interface 34 within the mount 39. As such, the user interface 34 pivots and is angled downward. As shown in FIG. 2C, the user interface 34 pivots and is angled upward.

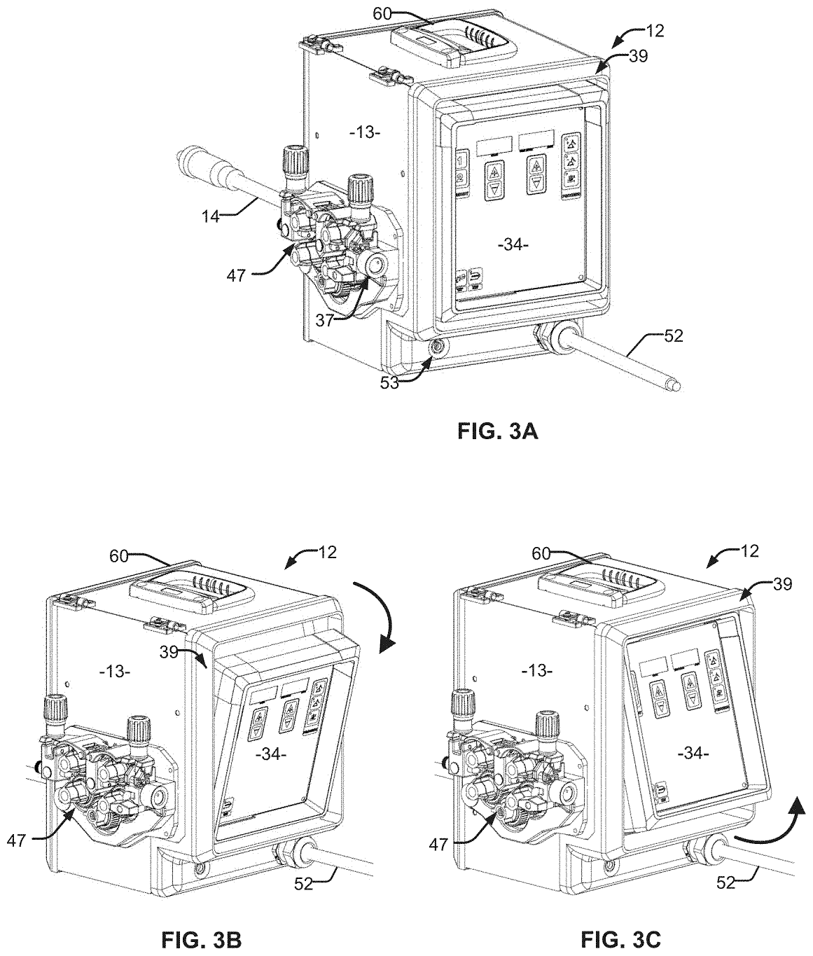

FIGS. 3A to 3C illustrate additional perspective views of an example wire feeder with an adaptable user interface, with FIG. 3B illustrating the user interface 34 pivoting downward, while FIG. 3C illustrates the user interface 34 pivoting upward.

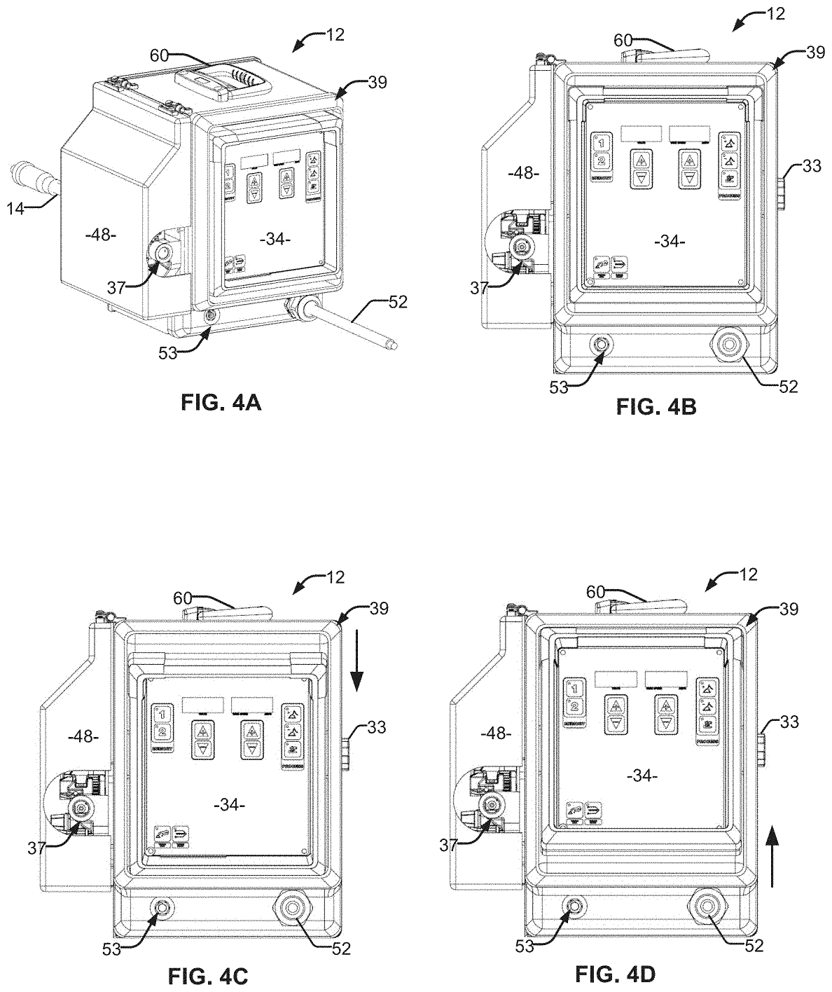

FIGS. 4A to 4D illustrate additional views generally of the front perspective of the example wire feeder 12. As shown, FIG. 4C illustrates the user interface 34 pivoting downward, while FIG. 4D illustrates the user interface 34 pivoting upward.

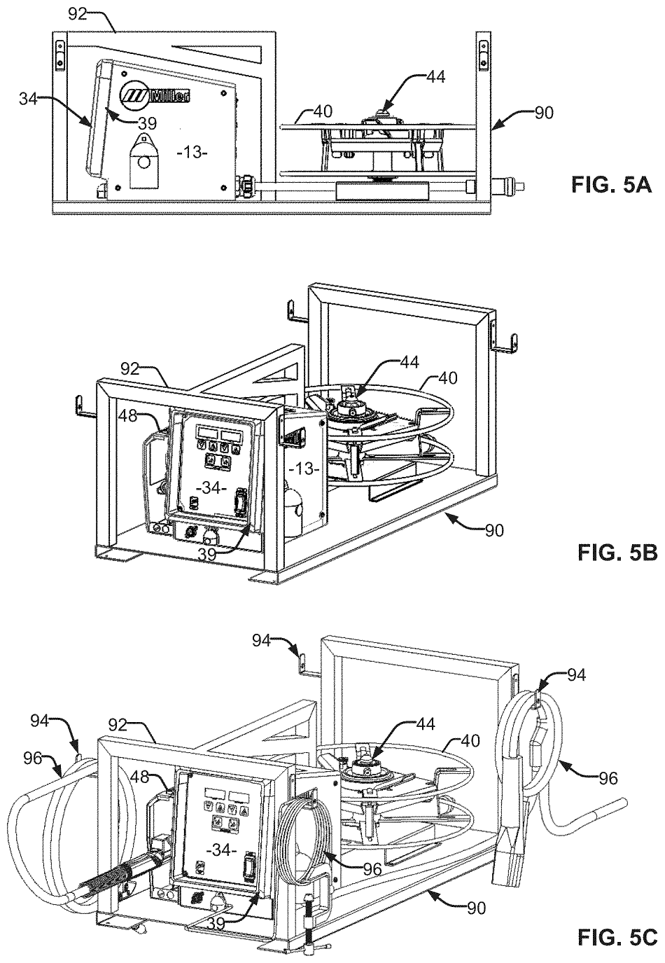

FIGS. 5A to 5C illustrate perspective views of the example wire feeder 12 with the adaptable user interface 34 mounted within an enclosure 90. In the example of FIGS. 5A to 5C, the wire feeder 12 and/or the enclosure 90 may be placed on a cart, along with a spool of wire 40, tools, etc. If the user interface was in a fixed orientation, the operator must be in a position to clearly see the front panel of the wire feeder 12. However, if the operator is performing a weld above or below a line of sight of the front panel, the operator would have to leave the work space in order to view and/or access the user interface.

As shown, the wire feeder 12 is protected within the enclosure 90 (e.g., by one or more beams/posts 92). The enclosure 90 further provides one or more hooks 94 for one or more tools or cables 96. However, the addition of the enclosure and/or tools may require more space and/or a relatively flat surface to secure the enclosure 90 to perform a welding operation, which may further limit the operator's field of view. Thus, the capability to change the position, orientation, and/or location of the user interface 34 provides specific advantages over rigid applications of a user interface.

The present methods and systems may be realized in hardware, software, and/or a combination of hardware and software. Example implementations include an application specific integrated circuit and/or a programmable control circuit. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

1. A wire feeder comprising:
a user interface;
a housing comprising a mount to receive the user interface, the user interface being secured to the mount by one or more non-permanent joints to allow the user interface to change an angle or a location of the user interface relative to a surface of the housing on which the user interface is secured; and
one or more fasteners configured to allow adjustment of a tension on the user interface from the one or more non-permanent joints.

2. The wire feeder of claim 1, wherein the one or more fasteners comprises one or more of a screw, a bolt, a magnet, a strap, a snap-fit, a detent, a magnet, or a removable pin.

3. The wire feeder of claim 1, wherein the user interface comprises one or more of a control switch or a display.

4. The wire feeder of claim 3, wherein a change in the angle or location of the user interface causes a change in an angle or a location of the control switch or the display of the user interface.

5. The wire feeder of claim 1, wherein the user interface is removable from the mount.

6. The wire feeder of claim 5, wherein the user interface is configured to be removed from the wire feeder and incorporated with another welding-type system, the user interface configured to control the wire feeder or the welding-type system.

7. The wire feeder of claim 1, wherein the mount includes rails on which the user interface can move within the mount.

8. The wire feeder of claim 1, wherein the wire feeder is secured in an enclosure.

9. The wire feeder of claim 8, wherein the enclosure is located on a cart.

10. A welding system comprising:
a user interface;
a mount to receive the user interface, the user interface being secured to the mount at one or more pivot points to allow an angle of the user interface to change relative to the mount on which the user interface is secured; and
a fastener configured to occupy a first position and a second position, wherein the first position allows the user interface to pivot about the one or more pivot points, and the second position fixes the angle of the user interface relative to the mount.

11. The welding system of claim 10, wherein the welding system is a wire feeder.

12. The welding system of claim 10, wherein the welding system is a welding power supply.

13. The welding system of claim 10, wherein the welding system is a remote.

14. The welding system of claim 10, wherein the fastener comprises one or more of a screw, a bolt, a magnet, a strap, a snap-fit, a detent, a magnet, or a removable pin.

15. The welding system of claim 10, wherein the user interface comprises one or more of a control switch or a display.

16. The welding system of claim 15, wherein a change in the angle or location of the user interface causes a change in an angle or a location of the control switch or the display of the user interface.

17. The welding system of claim 10, wherein the user interface is removable from the mount.

18. The welding system of claim 17, wherein the user interface is configured to be removed from the wire feeder and incorporated with another welding-type system, the user interface configured to control the wire feeder or the welding-type system.

19. The welding system of claim 10, wherein the wire feeder is secured in an enclosure.

20. The welding system of claim 19, wherein the enclosure is located on a cart.
